(19) United States
(12) Patent Application Publication
(10) Pub. No.: US 2023/0012328 A1
(43) Pub. Date: Jan. 12, 2023

(54) METHOD AND SYSTEM FOR CO-ORDINATING UNAVAILABILITY PERIOD PARAMETER OF UE IN WIRELESS NETWORK

(71) Applicant: Samsung Electronics Co., Ltd., Suwon-si (KR)

(72) Inventors: Lalith KUMAR, Bangalore (IN); Alok Kumar JANGID, Bangalore (IN); Kailash Kumar JHA, Bangalore (IN); Ravi Pandappa KAMALADINNI, Bangalore (IN)

(21) Appl. No.: 17/858,511

(22) Filed: Jul. 6, 2022

(30) Foreign Application Priority Data
Jul. 7, 2021 (IN) 202141030565
Jun. 22, 2022 (IN) 2021 41030565

(51) Int. Cl. H04W 76/25; H04W 48/16; H04W 60/06

(52) U.S. Cl. CPC H04W 76/25; H04W 48/16; H04W 60/06

(57) ABSTRACT

The disclosure relates to a 5G or 6G communication system for supporting a higher data transmission rate. A method for coordinating an unavailability period parameter of User Equipment (UE) in wireless network is provided. The method includes determining, by an Application Function (AF) of a network apparatus in the wireless network, the unavailability period parameter for the UE based on at least one event to be performed at the UE. Further, the method includes sending, by the AF of the network apparatus, the unavailability period parameter for the UE to an Access and Mobility Management Function (AMF) of the network apparatus. Further, the method includes configuring the unavailability period parameter at the UE. In an embodiment, UE detects it has to execute the event, UE initiates a non-access stratum (NAS) procedure to indicate it will become unavailable by indicating the unavailability period parameter to the 5th generation core (5GC), 5GC forwards the unavailability period parameter to the AF, with this the co-ordination between UE, 5GC and AF is achieved.

### CROSS-REFERENCE TO RELATED APPLICATION(S)

This application is based on and claims priority under 35 U.S.C. § 119(a) of an Indian Provisional patent application number 202141030565, filed on Jul. 7, 2021, in the Indian Patent Office, and of an Indian Complete patent application number 202141030565, filed on Jun. 22, 2022, in the Indian Patent Office, the disclosure of each of which is incorporated by reference herein in its entirety.

### BACKGROUND

### 1. Filed

The disclosure relates to a field of a wireless network. More particularly, the disclosure relates to a method and a system for co-ordinating unavailability period parameter of a User Equipment (UE) in the wireless network.

### 2. DESCRIPTION OF RELATED ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In general, a User Equipment (UE) becomes unavailable in the order of minutes whenever unavailability event (also called as event in this embodiment) for example upgrades is performed by the UE. Further, the UEs become unavailable without an application server or a core network having knowledge about it. This may impact the critical operations of the application server, if the UE is responsible for it during the “unavailability period” of the UE. Thus, there is a need for co-ordination between the UE and a Network/Application Function.

For example if the application server is aware that the UE will not be available for up to 3 minutes at 12 PM in the night due to an operating system (OS) upgrade it may assign alternate (or backup) UE to perform the respective critical operation and take care that alternate UE does not get into upgrade operation during same period. In yet another example, the application server may expect the UE to report certain information from industrial complex at 5 in the evening, but UE suddenly becomes unavailable at 5 due to unavailability event without the application server knowledge this non coordination has a potential to impact the application services which could be of critical nature like mission critical services etc.

Thus, it is desired to address the above mentioned disadvantages or other shortcomings or at least provide a useful alternative to avoid impact to the services of the UE.

The principal object of the embodiments herein is to provide a method and a system for co-ordinating unavailability period parameter of a UE in a wireless network. The proposed method provides the co-ordination between the UE, a 5th generation (5G) core (5GC) network and an Application Function (AF) (also commonly called as application server) when exactly UE can become unavailable so that an application server is not impacted with the surprise of UE becoming unavailable. When the UE sends a request to become unavailable, the 5GC/AF decides if it's appropriate time for the UE to become unavailable and indicate back to the UE if it can become unavailable or it cannot become unavailable.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure of the disclosure is to provide a method and a system for co-ordinating unavailability period parameter of a UE in the wireless network.

Additional aspects will be set forth in part in the description which follows and, in part, will be apparent from the description, or may be learned by practice of the presented embodiments.

In accordance with an aspect of the disclosure, a method for coordinating an unavailability period parameter of a UE in a wireless network is provided. The method includes determining, by an Application Function (AF) of a network apparatus in the wireless network, the unavailability period parameter for the UE based on at least one event to be performed at the UE. Further, the method includes sending, by the AF of the network apparatus, the unavailability period parameter for the UE to an Access and Mobility Management Function (AMF) of the network apparatus. Further, the method includes configuring, by the AMF of the network apparatus, the unavailability period parameter at the UE.

In an embodiment, the AMF configures the unavailability period parameter at the UE based on at least one operator policy.

In an embodiment, sending, by the AF of the network apparatus, the unavailability period parameter for the UE to the AMF of the network apparatus includes sending, by the AF of the network apparatus, the unavailability period parameter for the UE to a Policy Control Function (PCF) of the network apparatus through a Network Exposure Function (NEF) of the network apparatus, and transmitting, by the PCF of the network apparatus, the unavailability period parameter during an Access and Mobility (AM) policy association to the AMF of the network apparatus.

In an embodiment, sending, by the AF of the network apparatus, the unavailability period parameter for the UE to the AMF of the network apparatus includes sending, by the AF of the network apparatus, the unavailability period parameter for the UE to a Unified data management (UDM) of the network apparatus, and transmitting, by the UDM of the network apparatus, the unavailability period parameter in a Nudm_subscription data management (SDM)_Get response to the AMF of the network apparatus, wherein the UDM uses a UE Parameters update through a UDM control plane procedure to configure the unavailability period parameter into the UE.

In an embodiment, the at least one event which makes the UE to become unavailable i.e. enter no service or limited service (the events listed here should be considered only as an example there can be other events in which UE may determine that it will enter into no service or limited service or will have to switch off/power down) is at least one of a silent reset at a modem of the UE, a security patch updates at the UE, an Operating System (OS) upgrade at the UE, a modem software update at the UE, a UE reboot upon modem setting changes via Open Mobile Alliance (OMA) Device Management (DM), and the network apparatus initiated Detach Request with “Re-Attach Required”, Discontinuous coverage of the UEs for e.g. when the UE is in the satellite access or satellite next generation radio access network (NG-RAN). When UE is about to enter discontinuous coverage due to which the UE will remain in no service in the satellite NG-RAN of the current serving PLMN. The UE with analytic information or some learning model knows UE will enter into no service or limited service.

In an embodiment, the method includes storing, by the AMF of the network apparatus, the received unavailability period parameter, and configuring, by the AMF of the network apparatus, the unavailability period parameter to the UE in the wireless network.

In accordance with another aspect of the disclosure, a method for coordinating an unavailability period parameter of a UE in a wireless network is provided. The method includes detecting, by the UE, at least one event to be performed at the UE. Further, the method includes receiving, by the UE, the unavailability period parameter for the UE from an AMF of a network apparatus in the wireless network. The unavailability period parameter is for example a time slot which indicates a time duration in which the UE is allowed to execute a non-access stratum (NAS) procedure like deregistration procedure or registration procedure to execute the at least one event at the UE. Further, the method includes configuring, by the UE, the unavailability period parameter received from the AMF of the network apparatus. Further, the method includes performing, by the UE, the NAS procedure like deregistration procedure or registration procedure and to execute the at least one event at the UE based on the configured unavailability period parameter.

In an embodiment, the method further includes storing, by the UE, the received unavailability period parameter.

In accordance with another aspect of the disclosure, a network apparatus for coordinating an unavailability period parameter of a UE in a wireless network is provided. The network apparatus includes an AMF controller communicatively coupled to a memory and a processor, and a UE unavailability controller communicatively coupled to the AMF controller. The UE unavailability controller determines the unavailability period parameter for the UE, using an AF of the network apparatus, based on at least one event to be performed at the UE. The unavailability period parameter is for example a time slot which indicates a time duration in which the UE is allowed to perform a NAS procedure like deregistration procedure and to execute the at least one event at the UE. Further, the UE unavailability controller sends the unavailability period parameter for the UE to an AMF of the network apparatus using the AF of the network apparatus. Further, the UE unavailability controller configures the unavailability period parameter at the UE using the AMF of the network apparatus.

In accordance with another aspect of the disclosure, a UE for coordinating an unavailability period parameter of the UE in a wireless network is provided. The UE includes a UE unavailability controller communicatively coupled to a memory and a processor. The UE unavailability controller detects at least one event to be performed at the UE and receives the unavailability period parameter for the UE from an AMF of a network apparatus in the wireless network. The unavailability period parameter is for example a time slot which indicates a time duration in which the UE is allowed to perform a NAS procedure like deregistration procedure or registration procedure and to execute the at least one event at the UE. Further, the UE unavailability controller configures the unavailability period parameter received from the AMF of the network apparatus. Further, the UE unavailability controller performs the NAS procedure like deregistration procedure or registration procedure to execute the at least one event at the UE based on the configured unavailability period parameter.

In accordance with another aspect of the disclosure, a method for coordinating an unavailability period parameter of a UE in a wireless network is provided. The method includes detecting, by the UE, at least one event to be performed at the UE. Further, the method includes determining, by the UE, the unavailability period parameter based on the at least one event to be performed at the UE. The unavailability period parameter is for example a time slot which indicates a time duration in which the UE is allowed to perform a NAS procedure like deregistration procedure or registration procedure and to execute the at least one event at the UE. Further, the method includes sending, by the UE, the unavailability period parameter to an AMF of the network apparatus as part of the NAS message like registration message or the deregistration message. Further, the method includes receiving, by the UE, one of an unavailability period parameter accept indication in the NAS message or an unavailability period parameter not accepted in the NAS message from the AMF of the network apparatus. Further, the method includes performing, by the UE, the NAS procedure like deregistration procedure to execute the at least one event at the UE upon receiving the unavailability period parameter accept indication in the NAS message from the AMF. The accept indication can be and not limited to a new information element (IE) or a new bit which indicates receive unavailability period parameter at network is accepted in any of the NAS messages or send the NAS accept message (like registration accept or deregistration accept message) to indicate acceptance of the unavailability period parameter or send back to the UE the new unavailability period parameter accepted to the network.

In accordance with another aspect of the disclosure, a method for coordinating an unavailability period parameter of a UE in a wireless network is provided. The method includes receiving, by an AMF of a network apparatus in the wireless network, the unavailability period parameter from the UE. Further, the method includes determining, by the AMF of the network apparatus, whether the UE is allowed to become unavailable for the at least one event. Further, the method includes sending, by the AMF of the network apparatus, one of “an unavailability period parameter accept indication in the NAS message in response to determining that UE becoming unavailable based on unavailability period parameter is allowed and is fine to execute the at least one event is accepted by the AMF” or “an unavailability period parameter reject is indicated in NAS message in response to determining that UE becoming unavailable based on the unavailability period parameter for example the time duration to execute the at least one event is not accepted by the AMF or any other 5GC NF.

In an embodiment, further, the method includes sending, by the AMF of the network apparatus, an event notification report comprising the received unavailability period parameter to one of a PCF, a UDM, and a Network Exposure Function (NEF) of the network apparatus. Further, the method includes sending, by one of the PCF, the UDM or the NEF of the network apparatus, the event notification report to an Application function (AF) of the network apparatus also called as application server. Thus, there is an end to end co-ordination between UE, 5GC and AF is achieved.

In an embodiment, further, the method includes storing, by the AMF of the network apparatus, the received unavailability period parameter. Further, the method includes configuring, by the AMF of the network apparatus, the unavailability period parameter to any other UE in the wireless network.

In accordance with another aspect of the disclosure, a network apparatus for coordinating an unavailability period parameter of a UE in a wireless network is provided. The network apparatus includes an AMF controller communicatively coupled to a memory and a processor, and a UE unavailability controller communicatively coupled to the AMF controller. The UE unavailability controller receives the unavailability period parameter from the UE using an AMF of a network apparatus. Further, the UE unavailability controller determines whether the UE is allowed to become unavailable to execute the at least one event is accepted. Further, the UE unavailability controller sends one of “an unavailability period parameter accept indication in the NAS message in response to determining that the UE is allowed to become unavailable to execute the at least one event is accepted by the AMF” or “an unavailability period parameter reject indication in the NAS message in response to determining that the UE is not allowed to become unavailable and to execute the at least one event is not accepted by the AMF or any other 5GC NF.

In accordance with another aspect of the disclosure, a UE for coordinating an unavailability period parameter of the UE in a wireless network is provided. The UE includes a UE unavailability controller communicatively coupled to a memory and a processor. The UE unavailability controller detects at least one event to be performed at the UE. The UE unavailability controller determines the unavailability period parameter based on the at least one event to be performed at the UE. The UE unavailability controller sends the unavailability period parameter to an AMF of the network apparatus. The UE unavailability controller receives one of an unavailability period parameter accept indication in the NAS message or an unavailability period parameter reject indication in the NAS message from the AMF of the network apparatus. The UE unavailability controller performs the NAS procedure (like the deregistration procedure or registration procedure) to execute the at least one event at the UE upon receiving the unavailability period parameter accept indication in the NAS message from the AMF. After receiving the unavailability period parameter accept indication execution of the NAS procedure is optional step, UE can directly execute the event without any further NAS procedures execution.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrating a scenario of interaction between a UE and an application function (AF) or a core network, according to the related art;

FIG. 2 illustrating a scenario of a network apparatus which will dynamically configure OS upgrade schedule for each UE, according to an embodiment of the disclosure;

FIG. 3 illustrates an example scenario in which a wireless network co-ordinates UE unavailability time, according to an embodiment of the disclosure;

FIG. 4 illustrates an example scenario in which a wireless network co-ordinates UE unavailability time handled by the UE, according to an embodiment of the disclosure;

FIG. 5 shows various hardware components of the UE, according to an embodiment of the disclosure;

FIG. 6 shows various hardware components of the network apparatus, according to an embodiment of the disclosure;

FIGS. 7 and 8 are flow charts illustrating a method, implemented by the network apparatus, for coordinating an unavailability period parameter of the UE in the wireless network, according to various embodiments of the disclosure; and

FIGS. 9 and 10 are flow charts illustrating a method, implemented by the UE, for coordinating the unavailability period parameter of the UE in the wireless network, according to various embodiments of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted s for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The embodiments herein achieve a method for coordinating an unavailability period parameter of a UE in a wireless network. The method includes determining, by an AF of a network apparatus in the wireless network, the unavailability period parameter for the UE based on at least one event to be performed at the UE. Further, the method includes sending, by the AF of the network apparatus, the unavailability period parameter for the UE to an AMF of the network apparatus. Further, the method includes configuring, by the AMF of the network apparatus, the unavailability period parameter at the UE.

The proposed method provides the co-ordination between the UE, the 5GC and the AF when exactly UE can become unavailable so that the application server is not impacted with the surprise of UE becoming unavailable. When the UE sends a request to become unavailable, 5GC/AF decides if it's appropriate time for the UE to become unavailable and indicate back to the UE if it can become unavailable or it cannot become unavailable. The proposed method will notify the UE about an operating System (OS) upgrades with time schedule considering the device availability status.

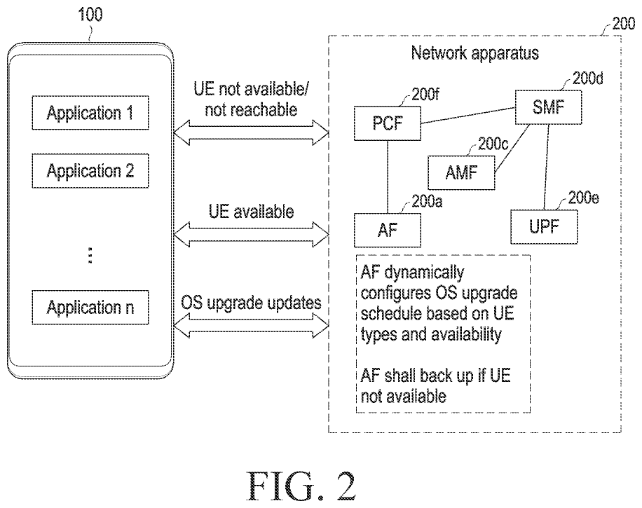

Referring now to the drawings and more particularly to FIGS. 2 through 10, where similar reference characters denote corresponding features consistently throughout the figures, there are shown preferred embodiments.

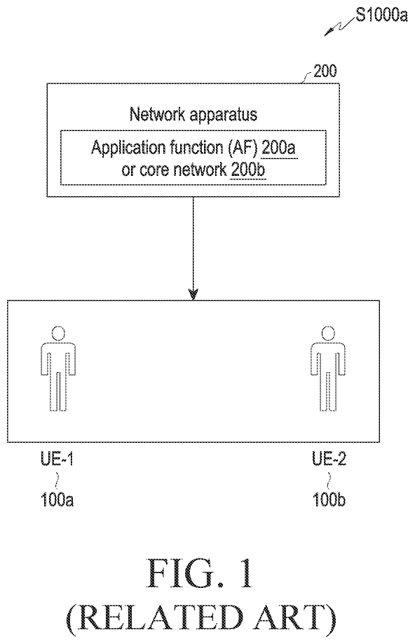

FIG. 1 illustrating a scenario (S1000a) of interaction between a UE (100a and 100b) and the application function (200a) or a core network (200b), according to the related art.

Referring to the FIG. 1, consider conventional methods and systems, the steps are, on the UE side, as follows:

The UE-1 & UE-2 (100a and 100b) has decided to perform upgrade procedure.

Both UE-1 && UE-2 (100a and 100b) decide to perform upgrade operation at 12 in the night.

They start upgrade procedure at 12 in the night and become unavailable to the network.

On the application function side, the steps are as follows:

At 12:01 an event occurs due to which the UE-1 (100a) is required to gather some data in the UE-1 environment. Thus, Application Function is trying to reach the UE-1 (100a). The UE-1 (100a) is unavailable.

The AF (200a) tries to reach UE-2 (100b), the UE-2 (100b) is also not available.

The AF (200a) is wondering why both the UEs (100a-100b) are not reachable and is not aware how long they are not available.

This non co-ordination of “unavailability time” may have impacts to the services of application function. The UE (100) can become unavailable for below examples and below unavailability events (also called as events in this embodiment) to perform unavailability operations:

Silent reset at Modem,

Security patch updates,

OS upgrade,

Modem feature or system SW updates,

Device reboot upon Modem setting changes via OMA-DM, and

Network initiated Detach Request with “Re-Attach Required”.

Discontinuous coverage of the UEs for e.g. when the UE is in the NG-RAN satellite access. I.e. when UE is about to enter discontinuous coverage.

UE with analytic information or some learning model knows UE will enter into no service or limited service.

FIG. 2 illustrating a scenario of the network apparatus (200) which will dynamically configure OS upgrade schedule for each UE, according to an embodiment of the disclosure.

Referring to the FIG. 2 consider a proposed method, illustrates the scenario of the network which will dynamically configures the OS upgrade schedule (unavailability period parameter) for each UE. The AF (200a) dynamically configures OS upgrade schedule based on UE types and availability. The AF (200a) shall back up if UE not available, the OS upgrade the status.

In an embodiment, the UE (100) detects at least one event to be performed at the UE (100) and receives the unavailability period parameter for the UE (100) from an AMF (200c) of the network apparatus (200). The at least one event may be, for example, but not limited to at least one of a silent reset at a modem of the UE (100), a security patch update at the UE (100), an OS upgrade at the UE (100), a modem software update at the UE (100), a UE reboot upon modem setting changes via Open Mobile Alliance (OMA) Device Management (DM), and the network apparatus initiated Detach Request with “Re-Attach Required”, Discontinuous coverage of the UEs for e.g. when the UE (100) is in the NG-RAN satellite access. I.e. when the UE (100) is about to enter discontinuous coverage, the UE (100) with analytic information or some learning model knows UE will enter into no service or limited service. Further, the UE (100) is configured with the unavailability period parameter received from the AMF (200c) of the network apparatus (200). Further, the UE (100) performs the NAS procedure like deregistration procedure or registration procedure and execute the at least one event at the UE (100) based on the configured unavailability period parameter. Further, the UE (100) stores the received unavailability period parameter.

In another embodiment, the UE (100) detects the at least one event to be performed at the UE (100). Further, the UE (100) determines the unavailability period parameter based on the at least one event to be performed at the UE (100). Further, the UE (100) sends the unavailability period parameter to the AMF (200c) of the network apparatus (200). Further, the UE (100) receives one of the unavailability period parameter accept indication in the NAS message or the unavailability period parameter reject indication in the NAS message from the AMF (200c) of the network apparatus (200). Further, the UE (100) performs the NAS procedure like registration procedure or the deregistration procedure to execute the at least one event at the UE (100) based on the at least one of the determined unavailability period parameter at the UE and upon receiving the unavailability period parameter accept indication in the message from the AMF (200c).

In yet another embodiment, the AF (200a) of the network apparatus (200) determines the unavailability period parameter for the UE (100) based on the at least one event to be performed at the UE (100). Further, the AF (200a) of the network apparatus (200) sends the unavailability period parameter for the UE (100) to the UDM of the network apparatus (200). Further, the UDM of the network apparatus (200) transmits the unavailability period parameter in the Nudm_SDM_Get response to the AMF (200c) of the network apparatus (200). The UDM uses the UE parameters update through the UDM control plane procedure to configure the unavailability period parameter into the UE (100). Further, the AF (200a) of the network apparatus (200) sends the unavailability period parameter for the UE (100) to the PCF (200f) of the network apparatus (200) through the NEF (200g) of the network apparatus (200). Further, the PCF (200f) of the network apparatus (200) transmits the unavailability period parameter during the AM policy association to the AMF (200c) of the network apparatus (200).

Further, the AMF (200c) of the network apparatus (200) configures the unavailability period parameter at the UE (100). Further, the AMF (200c) of the network apparatus (200) stores the received unavailability period parameter. Further, the AMF (200c) of the network apparatus (200) configures the unavailability period parameter to any other UE in the wireless network (1000).

In an embodiment, the AMF (200c) of the network apparatus (200) receives the unavailability period parameter from the UE (100). Further, the AMF (200c) of the network apparatus (200) determines whether the UE (100) is allowed to become unavailable to execute the at least one event is accepted. Further, the AMF (200c) of the network apparatus (200) sends one of “an unavailability period parameter accept indication in the NAS message in response to determining that the UE (100) is allowed to become unavailable to execute the at least one event is accepted by the AMF (200c)” or “an unavailability period parameter reject indication message in response to determining by the 5GC network function (NF) like AMF that the UE (100) is not allowed to execute the at least one event.

Further, the AMF (200c) of the network apparatus (200) sends the event notification report comprising the received unavailability period parameter from the UE (100) to one of the PCF (200f), the UDM, and the NEF (200g) of the network apparatus (200). Further, the PCF (200f), the UDM or the NEF (200g) of the network apparatus (200) sends the event notification report to the AF (200a) of the network apparatus (200). Further, the AMF (200c) of the network apparatus (200) stores the received unavailability period parameter. Further, the AMF (200c) of the network apparatus (200) configures the unavailability period parameter to any other UE in the wireless network (1000).

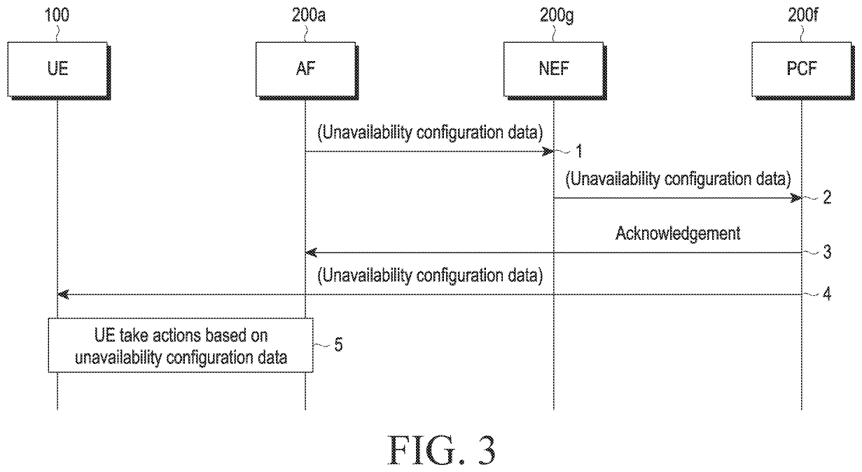

FIG. 3 illustrates an example scenario in which the wireless network (1000) co-ordinates UE unavailability time, according to an embodiment of the disclosure.

Referring to the FIG. 3, based on the proposed method, the wireless network (1000) shall notify the UE (100) about the OS upgrades with time schedule considering the device availability status. The steps are as follows:

At operation 1 of FIG. 3: The AF (200a) dynamically configure unavailability configuration data (also called as unavailability period parameter in this embodiment) in the 5G core network (200b) through the NEF (200g) if the AF (200a) is not in the trusted domain.

At operation 2 of FIG. 3: The NEF (200g) authorizes the AF (200a) (if required) and passes the unavailability configuration data to the PCF (200f).

At operation 3 of FIG. 3: The PCF (200f) stores the received unavailability configuration data. The PCF (200f) may provide this configuration data to any other NF in the core network (200b).

At operation 4 of FIG. 3: The PCF (200f) notifies unavailability configuration data to the UE (100).

At operation 5 of FIG. 3: the UE (100) store the received unavailability configuration data. The UE (100) take actions based on unavailability configuration data.

Further, the AF (200a) should be able to configure in the PCF (200f) through the NEF (200g) (for untrusted case) and directly in the PCF (200f) (For trusted case), “unavailability configuration data” as below:

UE's allowed “unavailability time” like time of the day, day of the week, day of the month or any other date. It may also be represented in the form of Start time and End time.

How long the UE (100) is allowed to remain unavailable. Duration in minutes or seconds.

Geographical area in which the UE (100) is allowed to be unavailable.

Geographical area in which the UE (100) is not allowed to be unavailable.

A timer value may be provided for e.g. Active timer at expiry of which UE is allowed to become unavailable.

The PCF (200f) should indicate this “unavailability configuration data” to the UE (100).

In an embodiment, the PCF (200f) here is taken as an example it may be any other new Network function (NF) or existing NF like UDM, UDR, NSSF etc.

The UE (100) should perform OS upgrades or any other procedure which requires it to become unavailable with the network during the allowed time as configured in “unavailability configuration data”.

In another embodiment, the UE (100) becoming unavailable means the UE (100) is not reachable for paging from the network perspective. Even if network pages the UE (100), the UE (100) will not be able to hear the paging message. I.e. AMF or any other 5GC NF will not initiate for paging the UE during the unavailability period or unavailability duration.

The UE behaviour based on “unavailability configuration data”:

The UE (100) should become unavailable for “unavailable events” only at the time slot indicated in the configuration.

The UE (100) should remain unavailable only for duration indicated. For example, the duration starts after the start time indicated in the configuration, if no start time then UE may immediately start the timer or optionally after the execution of the current NAS procedure.

The UE (100) should attempt to become unavailable only in the geographical area indicated in the configuration “Geographical area in which the UE (100) is allowed to be unavailable”.

The UE (100) should not attempt to become unavailable in the geographical area indicated in the configuration “Geographical area in which the UE (100) is not allowed to be unavailable”.

In yet another embodiment, Time may be given preference over the geographical area (e.g., if time configuration is available then irrespective of geographical area configuration UE is allowed to become unavailable).

In an embodiment, Geographical area may be given preference over the time configuration. I.e. if the UE (100) is in a geographical area where upgrade is allowed then the UE (100) may neglect the time configuration.

In another embodiment, only if the UE (100) is in allowed geographical area and allowed time UE (100) will attempt to become unavailable to perform unavailable events.

A timer value may be provided for e.g. Active timer at expiry of which UE (100) is allowed to become unavailable. The timer is started when a signal is received from the network including this timer value.

In yet another embodiment, the UE becomes unavailable implies it is executing or it will execute the unavailability events or the events discussed in this embodiment.

When the UE (100) is initiated,

The UE (100) may indicate that it wants to remain unavailable to the core network (200b) like AMF (200c), PCF (200f), UDM any other network function (NF) or any new NF. Additionally, the UE (100) may indicate the user preference i.e. for example the time (i.e. duration) it is planning to go unavailable for example to execute events like upgrades. The UE (100) may also provide “unavailability configuration data” indicating its preference, including its future geographical area i.e. the assumed geographical area UE (100) will be in the future.

This “unavailability configuration data” information may be propagated to the AF (200a) by any of the CN NFs.

The AF (200a) or core network (200b) will provide an indication to the UE (100) that it is allowed to remain “unavailable” or it's not allowed to remain “unavailable” optionally based on “unavailability configuration data” provided by the UE (100).

Along with the indication AF (200a)/CN may provide “unavailability configuration data” to the UE (100). The UE (100) will take actions based on unavailability configuration data. 5GC will take actions based on unavailability configuration data i.e. it will decide whether the UE (100) is unavailable and may decide not to page the UE (100) or page the UE (100) in the expected geographical area which UE had indicated it will be in the future.

In an embodiment, the terms “unavailability configuration data” and unavailability period parameter are used interchangeably but have the same meaning it may be called with any other name

The “unavailability configuration data” also called as unavailability period parameter in this embodiment is described as below and has at least one of the below parameter in any combination:

Time slot: The UE (100) should/will become unavailable for events only at the time slot indicated in the configuration for example between 4 to 5 PM or 11.30 to 12.30 AM etc.

Timer i.e. Duration: Time in minutes/seconds/hours the UE (100) should/will remain unavailable only for duration indicated. For example, the duration starts after the start time indicated in the configuration or after the unavailable accept indication is received by the UE or the moment UE indicates to the network.

Allowed Geographical area: The UE (100) should/will attempt to become unavailable by executing the event only in the geographical area indicated in the configuration “Geographical area in which the UE (100) is allowed to become unavailable”.

Not allowed Geographical area: The UE (100) should/will not attempt to become unavailable in the geographical area indicated in the configuration “Geographical area in which the UE (100) is not allowed to become unavailable”.

In another embodiment, Time may be given preference over the geographical area (e.g., if time configuration is available then irrespective of geographical area configuration UE is allowed to become unavailable).

In an embodiment, Geographical area may be given preference over the time configuration. I.e. if the UE (100) is in a geographical area where the UE (100) is allowed to execute the event then UE may neglect the time configuration.

In another embodiment, only if the UE (100) is in allowed geographical area and allowed time UE (100) will attempt to become unavailable to perform unavailability events.

Active timer: A timer value may be provided for e.g. Active timer at expiry of which UE (100) is allowed to become unavailable. The timer is started when a signal is received from the network including this timer value.

Future geographical area i.e. the assumed geographical area UE (100) will be in the future time which UE may determine based on implementation for e.g. following the UE speed, trajectory, route etc. The network may use this information to decide where to page the UE at the future time. Optionally this future time may be after the unavailability period of the UE.

Indication to execute the unavailability event immediately. The UE will execute the event immediately.

Indication to take user preference into account or not to take user preference into account. Based on this indication UE will choose to take user preference into account or act based on unavailability configuration data.

When the clash handling between multiple AFs—

“Unavailability configuration data” is provided by per application, in case of clash of parameters in the “unavailability configuration data” between multiple application functions, based on operator policy or agreement with the application function, a single “unavailability configuration data” is provided to the UE by the 5GC.

“Unavailability configuration data” is provided by per application, in case of clash of parameters in the “unavailability configuration data” between multiple application functions, or otherwise, based on operator policy or agreement with the application function, all the “unavailability configuration data” per AF is provided to the UE (100). The UE (100) makes a decision based on its implementation which “unavailability configuration data” it should apply.

Further, some of the points are given here,

If CN determines that the UE (100) is not available based on analytics (for example with the help of NWDAF) it may inform the AF (200a) that the UE (100) is not available.

In an embodiment, per AF may also be interpreted for group of application functions which may be indicated by the group ID.

When network provides the UE that it has to initiate the upgrade i.e. it can be become unavailable, network may indicate that it should start the upgrade procedure immediately. Optionally an explicit indication to neglect user preferences may be included in this case user preferences are neglected.

If there is a clash between user preference on the UE (100) and network provided configuration for e.g., user indicates to perform unavailability operation (like OS upgrade) at 10 in the night but the configuration indicates to perform 12 in the night. UE (100) should renegotiate the “unavailability configuration data” with the network, in this case UE (100) will indicate the user preference. CN may propagate this to the AF. AF/CN may indicate the “unavailability configuration data” after taking the user preference into account, UE (100) can become unavailable based on the received “unavailability configuration data” without considering clash conditions or if clash persists it may indicate to the user and decide to perform unavailability operation based on the user input or received “unavailability configuration data”.

In another embodiment, the idea is that network should be able to guide the UE (100) when it has to perform unavailability operations, the term when may be implemented with different possibilities for e.g. by giving start time, end time, duration of time after receiving the configuration etc. and time value may be indicated in any other implementable mechanism.

In yet another embodiment, the idea is that network should be able to guide the UE (100) when it has to perform unavailability operations i.e. the events described in this embodiment, the term when may be implemented with different possibilities for e.g. depending on which applications are sending or receiving the data, whether UE (100) is in IDLE state/INACTIVE state or Connected state etc.

In an embodiment, the idea is that network should be able to guide the UE (100) where it has to perform unavailability operations i.e. events, the term where may be implemented by providing geographical areas (e.g. TAI, TAI list, Cell-ID, GPS locations, longitude, latitude etc.) where the UE (100) is allowed to perform the events or not allowed to perform the events.

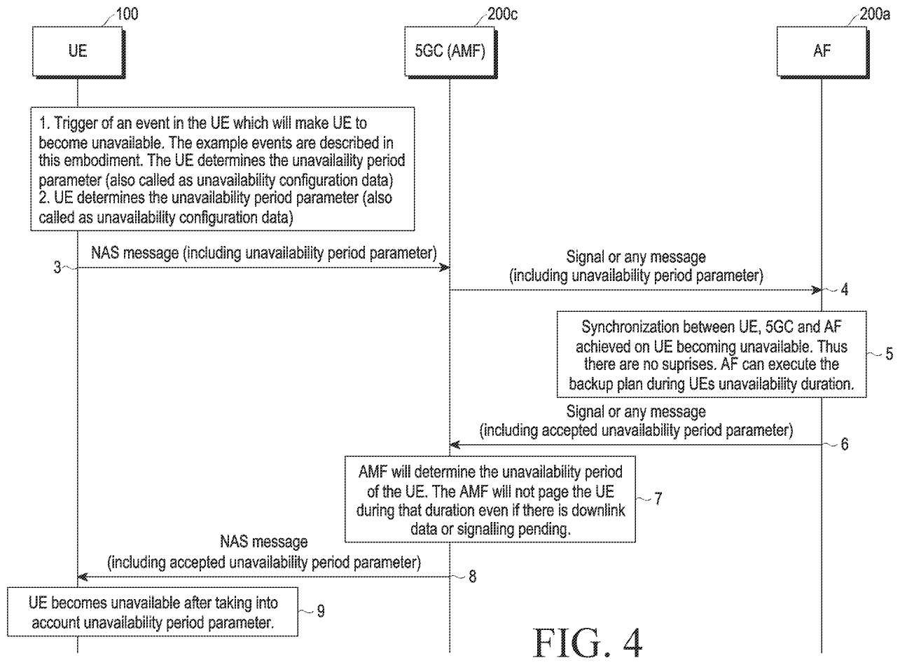

FIG. 4 illustrates an example scenario in which the wireless network co-ordinates UE unavailability time handled by the UE (100), according to an embodiment of the disclosure.

At operation 1 of FIG. 4, trigger of an event in the UE (100) which will make the UE (100) to become unavailable. The UE (100) determines the unavailability period parameter (also called as unavailability configuration data). At operation 2 of FIG. 4, the UE (100) determines the unavailability period parameter (also called as unavailability configuration data). At operation 3 of FIG. 4, the UE (100) sends the NAS message like registration request message or deregistration request message to the 5GC NF like AMF (200c). The NAS message includes the unavailability period parameter (also called as unavailability configuration data). The “unavailability configuration data” also called as unavailability period parameter in this embodiment is described as below and has at least one of the below parameter in any combination:

Time slot: The UE (100) should/will become unavailable for events only at the time slot indicated in the configuration for example between 4 to 5 PM or 11.30 to 12.30 AM etc.

Timer i.e. Duration: Time in minutes/seconds/hours the UE (100) should/will remain unavailable only for duration indicated. For example, the duration starts after the start time indicated in the configuration or after the unavailable accept indication is received by the UE or the moment UE indicates to the network.

Allowed Geographical area: The UE (100) should/will attempt to become unavailable by executing the event only in the geographical area indicated in the configuration “Geographical area in which the UE (100) is allowed to become unavailable”.

Not allowed Geographical area: The UE (100) should/will not attempt to become unavailable in the geographical area indicated in the configuration “Geographical area in which the UE (100) is not allowed to become unavailable”.

In an embodiment, Time may be given preference over the geographical area (e.g., if time configuration is available then irrespective of geographical area configuration UE is allowed to become unavailable).

In another embodiment, Geographical area may be given preference over the time configuration. I.e. if the UE (100) is in a geographical area where the UE (100) is allowed to execute the event then UE may neglect the time configuration.

In yet another embodiment, only if the UE (100) is in allowed geographical area and allowed time UE (100) will attempt to become unavailable to perform unavailability events.

Active timer: A timer value may be provided for e.g. Active timer at expiry of which UE (100) will become unavailable.

Future geographical area i.e. the assumed geographical area UE (100) will be in the future time which UE may determine based on implementation for e.g. following the UE speed, trajectory, route, analytics information or learning in the UE etc. The network may use this information to decide where to page the UE at the future time. Optionally this future time can be after the unavailability period of the UE i.e. after execution of the unavailability event.

Indication to execute the unavailability event immediately. The UE will execute the event immediately.

Indication to take user preference into account or not to take user preference into account. Based on this indication UE will choose to take user preference into account or act based on unavailability configuration data.

The geographical area in this embodiment is TAI, TAI list, Cell-ID, GPS locations, longitude, latitude or it may be another method to map the geographical area etc.

At operation 4 of FIG. 4, the 5GC NF like AMF propagates the unavailability period parameter received from the UE (100) to the application function (AF) (200a) also called as application server. The 5GC NF may be AMF, NEF, Session Management Function (SMF) 200d of FIG. 2, User Plane Function (UPF) 200e of FIG. 2 or any other new NF or old existing NF as per TS 23.501. The unavailability period parameter may be sent between this NFs for e.g. the AMF (200c) may send to the PCF (200c) and forward to the NEF (200g) then finally this unavailability period parameter may be propagated to the AF (200a). In summary, the 5GC forwards this unavailability period parameter to the AF (200a). The AMF (200c) or any other NF may update the one or more configurations in the unavailability period parameter before sending it to the AF (200a) based on local policy, subscription or any other implementation dependent mechanisms.

At operation 5 of FIG. 4, the synchronization between the UE (100), the 5GC and the AF (200c) is achieved on the UE becoming unavailable. Further, the AF (200a) may execute the backup plan during UEs unavailability duration which is determined based on unavailability period parameter. At operation 6 of FIG. 4, the AF (200a) may respond back with the unavailability period parameter to the 5GC indicating its preference.

At operation 7 of FIG. 4, the 5GC NF like AMF (200c) will determine the unavailability period of the UE (100). The AMF (200c) will not page the UE (100) during the duration of unavailability period or in the geographical location/time UE is expected to remain unavailable even if there is downlink data or downlink signaling pending for the UE. The 5GC NF like AMF (200c) finally determines the parameters or configuration of the unavailability period parameter and send back to the UE (100) as final accepted unavailability period parameter. If received UE uses the unavailability period parameter sent by the network as final unavailability period parameter to determine the unavailability period to execute at least one event.

At operation 8 of FIG. 4, The UE (100) determines the unavailability period parameter is accepted by the network, and indicates to the upper layers/user (for example through an AT command etc.) that unavailability period is accepted, in at least one of the below cases:

The UE (100) receives the response NAS message like registration accept or service accept.

The new unavailability period parameter which is accepted by network is received in NAS message like registration accept, UE configuration update command, DL NAS TRANSPORT etc.

Dedicated indication in the NAS message like registration accept, UE configuration update command, DL NAS TRANSPORT etc. indicating to the UE (100) that the UE (100) is allowed to become unavailable and unavailability period parameter sent by the UE (100) is accepted by network and/or application function.

When UE determines that the unavailability period parameter is accepted by the network, then UE-NAS indicates to the upper layers/user (for example through an AT command etc.) that unavailability period parameter is sent to network/AF successfully.

The UE determines that the unavailability period parameter is not accepted by the network or not successfully delivered to the network/AF if:

The NAS procedure carrying the unavailability period parameter is not successful. I.e. UE receives a NAS response message as reject message for example registration reject, deregistration reject, service reject etc.

In response NAS message like registration accept, service accept or deregistration accept the unavailability period parameter is not included.

The NAS procedure carrying the unavailability period parameter faces abnormal cases for example NAS procedure guard timer expiry like T3510 timeout, Lower layer failure, Transmission failure.

Dedicated indication in the NAS message like registration accept, UE configuration update command, DL NAS TRANSPORT etc. indicating to the UE (100) that the UE (100) is not allowed to become unavailable and unavailability period parameter sent by the UE (100) is not accepted by network and/or application function.

When UE determines that the unavailability period parameter is not accepted by the network, then UE-NAS indicates to the upper layers/user (for example through an AT command etc.) that unavailability period parameter sent to network/AF is not successful. The UE or upper layers may decide to re-attempt sending the unavailability period parameter to the network/AF. The UE may delay execution of the event etc.

At operation 9 of FIG. 4, the UE (100) becomes unavailable based on unavailability period parameter and execute the event. For example, the UE (100) uses the duration of unavailability period, start time and duration, geographical location into account to execute the event and become unavailable.

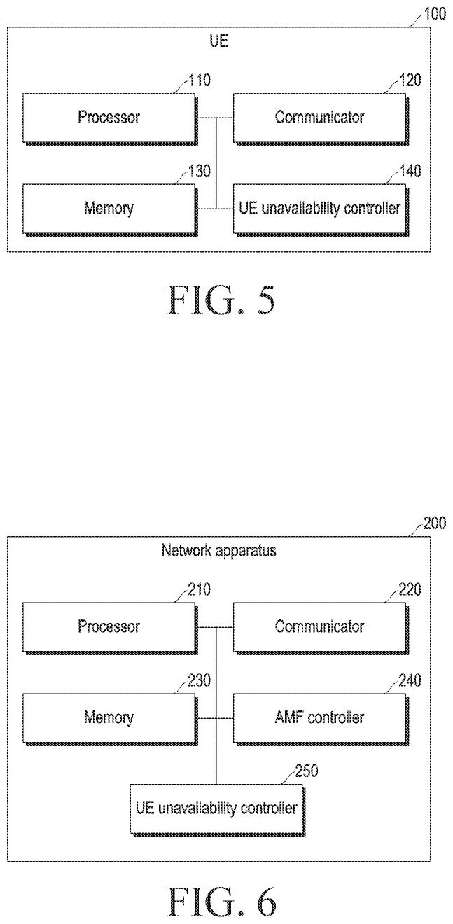

FIG. 5 shows various hardware components of the UE (100), according to an embodiment of the disclosure.

Referring to FIG. 5, the UE (100) includes a processor (110), a communicator (120), a memory (130) and a UE unavailability controller (140). The processor (110) is coupled with the communicator (120), the memory (130) and the UE unavailability controller (140).

In an embodiment, the UE unavailability controller (140) detects the at least one event to be performed at the UE (100) and receives the unavailability period parameter for the UE (100) from the AMF (200c) of the network apparatus (200). Further, the UE unavailability controller (140) configures the unavailability period parameter received from the AMF (200c) of the network apparatus (200). Further, the UE unavailability controller (140) becomes unavailable by performing the NAS procedure like deregistration procedure or registration procedure and execute the at least one event at the UE (100) based on the configured unavailability period parameter. Further, the UE unavailability controller (140) stores the received unavailability period parameter.

In another embodiment, the UE unavailability controller (140) detects the at least one event to be performed at the UE (100). Further, the UE unavailability controller (140) determines the unavailability period parameter based on the at least one event to be performed at the UE (100). Further, the UE unavailability controller (140) sends the unavailability period parameter to the AMF (200c) of the network apparatus (200). Further, the UE unavailability controller (140) receives one of the unavailability period parameter accept indication in the NAS message or the unavailability period parameter reject indication in the NAS message from the AMF (200c) of the network apparatus (200). Further, the UE unavailability controller (140) performs the NAs procedure like deregistration procedure to execute the at least one event at the UE upon receiving the unavailability period parameter accept indication from the AMF (200c).

The UE unavailability controller (140) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 5 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the disclosure. One or more components may be combined together to perform same or substantially similar function in the UE (100).

FIG. 6 shows various hardware components of the network apparatus (200), according to an embodiment of the disclosure.

Referring to FIG. 6, the network apparatus (200) includes a processor (210), a communicator (220), a memory (230), an AMF controller (240), and a UE unavailability controller (250). The processor (210) is coupled with the communicator (220), the memory (230), the AMF controller (240) and the UE unavailability controller (250).

In an embodiment, the UE unavailability controller (250) determines the unavailability period parameter for the UE (100), using the AF (200a) of the network apparatus (200), based on the at least one event to be performed at the UE (100).

Further, the UE unavailability controller (250) sends the unavailability period parameter for the UE (100) to the AMF (200c) using the AF (200a) of the network apparatus (200). In an embodiment, the UE unavailability controller (250) sends the unavailability period parameter for the UE (100) to the PCF (200f) of the network apparatus (200) through the NEF (200g) of the network apparatus (200) using the AF (200a) of the network apparatus (200). Further, the UE unavailability controller (250) transmits the unavailability period parameter during the AM policy association to the AMF (200c) of the network apparatus (200) using the PCF (200f) of the network apparatus (200). In another embodiment, the UE unavailability controller (250) sends the unavailability period parameter for the UE (100) to the UDM of the network apparatus (200). Further, the UE unavailability controller (250) transmits the unavailability period parameter in a Nudm_SDM_Get response to the AMF (200c) of the network apparatus (200). The UDM uses the UE parameters update through a UDM control plane procedure to configure the unavailability period parameter into the UE (100).

Further, the UE unavailability controller (250) configures the unavailability period parameter at the UE (100) using the AMF (200c) of the network apparatus (200). Further, the UE unavailability controller (250) stores the received unavailability period parameter and configures the unavailability period parameter to the UE in the wireless network (1000) using the AMF (200c) of the network apparatus (200).

In another embodiment, the UE unavailability controller (250) receives the unavailability period parameter from the UE (100) using the AMF (200c) of the network apparatus (200) and determines, using the AMF (200c) of the network apparatus (200), whether the UE (100) is allowed to become unavailable to execute the at least one event is accepted. Further, the UE unavailability controller (250) sends one of “an unavailability period parameter accept indication in the NAS message in response to determining that the UE (100) is allowed to become unavailable to execute the at least one event is accepted by the AMF (200c)” or “an unavailability period parameter reject indication in the NAS message in response to determining that the UE (100) is not allowed to become unavailable to execute the at least one event.

Further, the UE unavailability controller (250) sends an event notification report comprising the received unavailability period parameter to one of the PCF (200f), a UDM, and the NEF (200g) of the network apparatus (200) and sends the event notification report an AF (200a) of the network apparatus (200) using one of the PCF (200f), the UDM or the NEF (200g) of the network apparatus (200).

Further, the UE unavailability controller (250) stores the received unavailability period parameter using the AMF (200c) of the network apparatus and configures the unavailability period parameter to any other UE in the wireless network (1000) using the AMF (200c) of the network apparatus.

The AMF controller (240) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The UE unavailability controller (250) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 6 shows various hardware components of the network apparatus (200) but it is to be understood that other embodiments are not limited thereon. In other embodiments, the network apparatus (200) may include less or more number of components. Further, the labels or names of the components are used only for illustrative purpose and does not limit the scope of the disclosure. One or more components may be combined together to perform same or substantially similar function in the network apparatus (200).

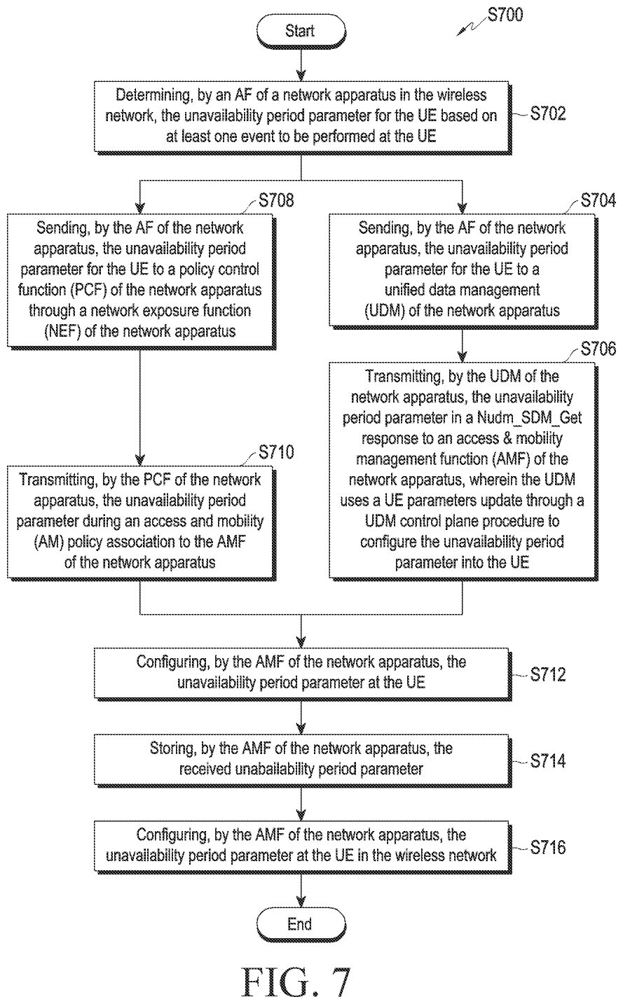

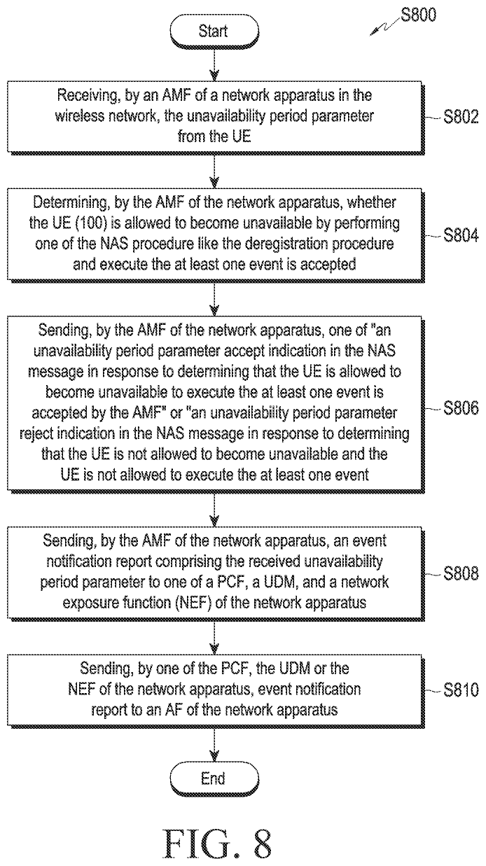

FIGS. 7 and 8 are flow charts (S700 and S800) illustrating a method, implemented by the network apparatus (200), for coordinating the unavailability period parameter of the UE (100) in the wireless network (1000), according to various embodiments of the disclosure.

Referring to the FIG. 7, at operation S702, the AF (200a) of the network apparatus (200) determines the unavailability period parameter for the UE (100) based on the at least one event to be performed at the UE (100). At operation S704, the AF (200a) of the network apparatus (200) sends the unavailability period parameter for the UE (100) to the UDM of the network apparatus (200).

At operation S706, the UDM of the network apparatus (200) transmits the unavailability period parameter in the Nudm_SDM_Get response to the AMF (200c) of the network apparatus (200). The UDM uses the UE parameters update through the UDM control plane procedure to configure the unavailability period parameter into the UE (100). At operation S708, the AF (200a) of the network apparatus (200) sends the unavailability period parameter for the UE (100) to the PCF (200f) of the network apparatus (200) through the NEF (200g) of the network apparatus (200). At operation S710, the PCF (200f) of the network apparatus (200) transmits the unavailability period parameter during the AM policy association to the AMF (200c) of the network apparatus (200).

At operation S712, the AMF (200c) of the network apparatus (200) configures the unavailability period parameter at the UE (100). At operation S714, the AMF (200c) of the network apparatus (200) stores the received unavailability period parameter. At operation S716, the AMF of the network apparatus (200) configures the unavailability period parameter to the UE in the wireless network (1000).

Referring to the FIG. 8, at operation S802, the AMF (200c) of the network apparatus (200) receives the unavailability period parameter from the UE (100). At operation S804, the AMF (200c) of the network apparatus (200) determines whether the UE (100) is allowed to become unavailable by performing one of the NAS procedure like the deregistration procedure and execute the at least one event is accepted. At operation S806, the AMF (200c) of the network apparatus (200) sends one of “an unavailability period parameter accept indication in the NAS message in response to determining that the UE (100) is allowed to become unavailable and to perform the deregistration procedure followed by execution of the at least one event is accepted by the AMF (200c)” or “an unavailability period parameter reject indication in the NAS message in response to determining that the UE (100) is not allowed to become unavailable, perform the deregistration procedure to execute the at least one event.

At operation S808, the AMF (200c) of the network apparatus (200) sends the event notification report or any other signal or any other message comprising the received unavailability period parameter from the UE to one of the PCF (200f), the UDM, and the NEF (200g) of the network apparatus (200). At operation S810, the PCF (200f), the UDM or the NEF (200g) of the network apparatus (200) sends the event notification report or any other signal or any other message comprising the received unavailability period parameter to the AF (200a) of the network apparatus (200). The aim of this step is to have a co-ordination between UE, 5GC and the AF. AF may be in network domain/operator domain or it may be a third party.

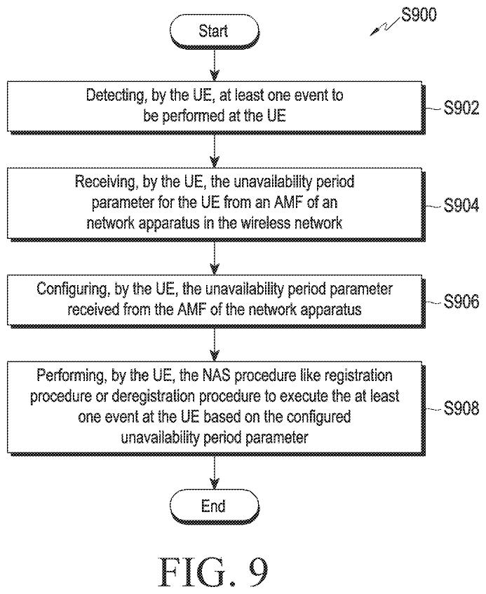

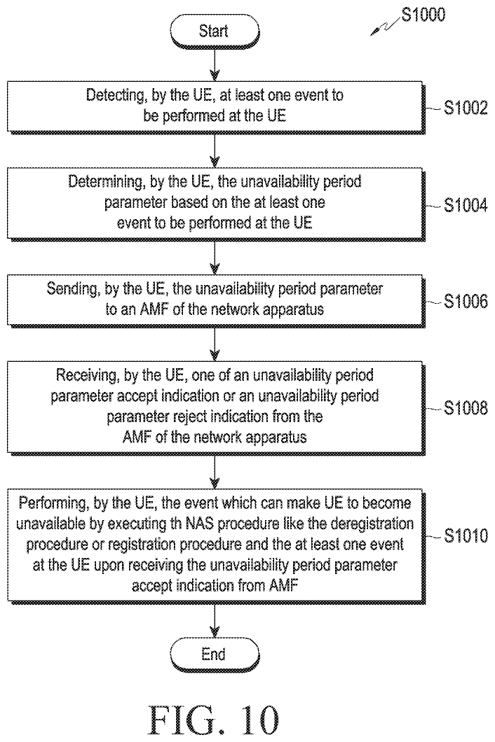

FIGS. 9 and 10 are flow charts (S900 and S1000) illustrating a method, implemented by the UE (100), for coordinating the unavailability period parameter of the UE (100) in the wireless network (1000), according to various embodiments of the disclosure.

Referring to the FIG. 9, the operations S902-S908 are handled by the UE unavailability controller (250). At operation S902, the method includes detecting the at least one event to be performed at the UE (100). At S904, the method includes receiving the unavailability period parameter for the UE (100) from the AMF (200c) of the network apparatus (200). At operation S906, the method includes configuring the unavailability period parameter received from the AMF (200c) of the network apparatus (200). At operation S908, the method includes performing the NAS procedure like registration procedure or deregistration procedure and to execute the at least one event at the UE (100) based on the configured unavailability period parameter

Referring to the FIG. 10, the operations (S1002-S1010) are handled by the UE unavailability controller (250). At operation S1002, the method includes detecting the at least one event to be performed at the UE (100). At operation S1004, the method includes determining the unavailability period parameter based on the at least one event to be performed at the UE (100). At operation S1006, the method includes sending the unavailability period parameter to the AMF (200c) of the network apparatus (200). At operation S1008, the method includes receiving one of the unavailability period parameter accept indication in the NAS message or the unavailability period parameter reject indication in the NAS message from the AMF (200c) of the network apparatus (200). At operation S1010, the method includes performing the event which may make UE to become unavailable by executing the NAS procedure (like the deregistration procedure or registration procedure) and the at least one event at the UE upon receiving the unavailability period parameter accept indication from the AMF (200c).

The various actions, acts, blocks, steps, or the like in the flow charts (S700-S1000) may be performed in the order presented, in a different order or simultaneously. Further, in some embodiments, some of the actions, acts, blocks, steps, or the like may be omitted, added, modified, skipped, or the like without departing from the scope of the disclosure.

According to an embodiment of the disclosure, a method for coordinating an unavailability period parameter of a User Equipment (UE) (100) in a wireless network (1000) may be provided, and the method may comprise:

determining, by an Application Function (AF) (200a) of a network apparatus (200) in the wireless network (1000), the unavailability period parameter for the UE (100) based on at least one event to be performed at the UE (100);

sending, by the AF (200a) of the network apparatus (200), the unavailability period parameter for the UE (100) to an Access and Mobility Management Function (AMF) (200c) of the network apparatus (200); and

configuring, by the AMF (200c) of the network apparatus (200), the unavailability period parameter at the UE (100).

According to an embodiment of the disclosure, the AMF (200c) may configure the unavailability period parameter at the UE (100) based on at least one operator policy.

According to an embodiment of the disclosure, sending, by the AF (200a), the unavailability period parameter for the UE (100) to the AMF (200c) may comprise

sending, by the AF (200a), the unavailability period parameter for the UE (100) to a Policy Control Function (PCF) (200f) of the network apparatus (200) through a Network Exposure Function (NEF) (200g) of the network apparatus (200); and

transmitting, by the PCF (200f), the unavailability period parameter during an Access and Mobility (AM) policy association to the AMF (200c) of the network apparatus (200).

According to an embodiment of the disclosure, sending, by the AF (200a), the unavailability period parameter for the UE (100) to the AMF (200c) may comprise:

sending, by the AF (200a), the unavailability period parameter for the UE (100) to a Unified data management (UDM) of the network apparatus (200); and

transmitting, by the UDM of the network apparatus (200), the unavailability period parameter in a Nudm_SDM_Get response to the AMF (200c) of the network apparatus, wherein the UDM uses a UE Parameters update through a UDM control plane procedure to configure the unavailability period parameter into the UE (100).

According to an embodiment of the disclosure, the at least one event may be at least one of a silent reset at a modem of the UE (100), a security patch update at the UE (100), an Operating System (OS) upgrade at the UE (100), a modem software update at the UE (100), a UE reboot upon modem setting changes via Open Mobile Alliance (OMA) Device Management (DM), the network apparatus initiated Detach Request with “Re-Attach Required”, Discontinuous coverage of the UEs.

According to an embodiment of the disclosure, the method may comprise:

storing, by the AMF (200c) of the network apparatus (200), the received unavailability period parameter; and

configuring, by the AMF (200c) of the network apparatus (200), the unavailability period parameter to the UE in the wireless network (1000).

According to an embodiment of the disclosure, a method for coordinating an unavailability period parameter of a User Equipment (UE) (100) in a wireless network (1000) may be provided, and the method may comprise:

detecting, by the UE (100), at least one event to be performed at the UE (100);

receiving, by the UE (100), the unavailability period parameter for the UE (100) from an AMF (200c) of a network apparatus (200) in the wireless network (1000) to execute the at least one event at the UE (100);

configuring, by the UE (100), the unavailability period parameter received from the AMF (200c) of the network apparatus (200); and

performing, by the UE (100), a NAS procedure to execute the at least one event at the UE (100) based on the configured unavailability period parameter.

According to an embodiment of the disclosure, the at least one event may be at least one of a silent reset at a modem of the UE (100), a security patch update at the UE (100), an Operating System (OS) upgrade at the UE (100), a modem software update at the UE (100), a UE reboot upon modem setting changes via Open Mobile Alliance (OMA) Device Management (DM), the network apparatus initiated Detach Request with “Re-Attach Required”, Discontinuous coverage of the UEs.

According to an embodiment of the disclosure, the method may comprise storing, by the UE (100), the received unavailability period parameter.

According to an embodiment of the disclosure, a network apparatus (200) for coordinating an unavailability period parameter of a UE (100) in a wireless network (1000) may be provided, and the network apparatus (200) may comprise:

a memory (230);

a processor (210);

an AMF controller (240) communicatively coupled to the memory (230) and the processor (210); and

a UE unavailability controller (250), communicatively coupled to the AMF controller (240), configured to:

determine the unavailability period parameter for the UE (100), using an Application Function (AF) (200a) of the network apparatus (200), based on at least one event to be performed at the UE (100);

send the unavailability period parameter for the UE (100) to an Access and Mobility Management Function (AMF) (200c) of the network apparatus (200) using the AF (200a) of the network apparatus (200); and

configure the unavailability period parameter at the UE (100) using the AMF (200c) of the network apparatus (200).

According to an embodiment of the disclosure, the AMF (200c) may configure the unavailability period parameter at the UE (100) based on at least one operator policy.

According to an embodiment of the disclosure, the UE may be configured to:

send the unavailability period parameter for the UE (100) to a Policy Control Function (PCF) (200f) of the network apparatus (200) through a Network Exposure Function (NEF) (200g) of the network apparatus (200) using the AF (200a) of the network apparatus (200); and

transmit the unavailability period parameter during an Access and Mobility (AM) policy association to the AMF (200c) of the network apparatus (200) using the PCF (200f) of the network apparatus (200).

According to an embodiment of the disclosure, the UE may be configured to:

send the unavailability period parameter for the UE (100) to a Unified data management (UDM) of the network apparatus (200); and

transmit the unavailability period parameter in a Nudm_SDM_Get response to the AMF (200c) of the network apparatus (200), wherein the UDM uses a UE Parameters update through a UDM control plane procedure to configure the unavailability period parameter into the UE (100).

According to an embodiment of the disclosure, the at least one event may be at least one of a silent reset at a modem of the UE (100), a security patch update at the UE (100), an Operating System (OS) upgrade at the UE (100), a modem software update at the UE (100), a UE reboot upon modem setting changes via Open Mobile Alliance (OMA) Device Management (DM), and the network apparatus initiated Detach Request with “Re-Attach Required”,”, Discontinuous coverage of the UEs.

According to an embodiment of the disclosure, the UE unavailability controller (250) may be configured to:

store the received unavailability period parameter; and

configure the unavailability period parameter to the UE in the wireless network (1000) using the AMF (200c) of the network apparatus (200).

According to an embodiment of the disclosure, a User Equipment (UE) (100) for coordinating an unavailability period parameter of the UE (100) in a wireless network (1000) may be provided, and the UE (100) may comprise:

a memory (130);

a processor (110); and

a UE unavailability controller (140), communicatively coupled to the memory (130) and the processor (110), configured to:

detect at least one event to be performed at the UE (100);

receive the unavailability period parameter for the UE (100) from an AMF (200c) of a network apparatus (200) to execute the at least one event at the UE (100);

configure the unavailability period parameter received from the AMF (200c) of the network apparatus (200); and

perform the NAS procedure to execute the at least one event at the UE (100) based on the configured unavailability period parameter.

According to an embodiment of the disclosure, the at least one event may be at least one of a silent reset at a modem of the UE (100), a security patch update at the UE (100), an Operating System (OS) upgrade at the UE (100), a modem software update at the UE (100), a UE reboot upon modem setting changes via Open Mobile Alliance (OMA) Device Management (DM), the network apparatus initiated Detach Request with “Re-Attach Required”, and Discontinuous coverage of the UEs.

According to an embodiment of the disclosure, the UE unavailability controller (140) may be configured to store the received unavailability period parameter.

According to an embodiment of the disclosure, a method for coordinating an unavailability period parameter of a User Equipment (UE) (100) in a wireless network (1000) may be provided, and the method may comprise:

detecting, by the UE (100), at least one event to be performed at the UE (100);

determining, by the UE (100), the unavailability period parameter based on the at least one event to be performed at the UE (100) to execute the at least one event at the UE (100);

sending, by the UE (100), the unavailability period parameter to an AMF (200c) of the network apparatus (200);

receiving, by the UE (100), one of an unavailability period parameter accept indication or an unavailability period parameter reject indication from the AMF (200c) of the network apparatus (200); and

performing, by the UE (100), the NAS procedure to execute the at least one event at the UE (100) upon receiving the unavailability period parameter accept indication from the AMF (200c).

According to an embodiment of the disclosure, the at least one event may be at least one of a silent reset at a modem of the UE (100), a security patch update at the UE (100), an Operating System (OS) upgrade at the UE (100), a modem software update at the UE (100), a UE reboot upon modem setting changes via Open Mobile Alliance (OMA) Device Management (DM), the network apparatus initiated Detach Request with “Re-Attach Required”, and Discontinuous coverage of the UEs.

According to an embodiment of the disclosure, a method for coordinating an unavailability period parameter of a User Equipment (UE) (100) in a wireless network (1000) may be provided, and the method may comprise:

receiving, by an AMF (200c) of a network apparatus (200) in the wireless network (1000), the unavailability period parameter from the UE (100), to execute at least one event at the UE (100);

determining, by the AMF (200c) of the network apparatus (200), whether UE (100) is allowed to become unavailable, perform the NAS procedure to execute the at least one event is accepted; and

sending, by the AMF (200c) of the network apparatus (200), one of an unavailability period parameter accept indication in response to determining that the UE (100) is allowed become unavailable, to perform the deregistration procedure and to execute the at least one event is accepted by the AMF (200c) or an unavailability period parameter reject indication in response to determining that the UE (100) is not allowed to become unavailable and to execute the at least one event.

According to an embodiment of the disclosure, the method may comprise:

sending, by the AMF (200c) of the network apparatus (200), an event notification report comprising the received unavailability period parameter from the UE (100) to one of a PCF (200f), a UDM, and a Network Exposure Function (NEF) (200g) of the network apparatus (200); and

sending, by one of the PCF (200f), the UDM or the NEF (200g) of the network apparatus (200), the event notification report to an AF (200a) of the network apparatus (200).

According to an embodiment of the disclosure, the at least one event may be at least one of a silent reset at a modem of the UE (100), a security patch updates at the UE (100), an Operating System (OS) upgrade at the UE (100), a modem software update at the UE (100), a UE reboot upon modem setting changes via Open Mobile Alliance (OMA) Device Management (DM), the network apparatus initiated Detach Request with “Re-Attach Required”, and Discontinuous coverage of the UEs.

According to an embodiment of the disclosure, the method may comprise:

storing, by the AMF (200c) of the network apparatus (200), the received unavailability period parameter; and

configuring, by the AMF (200c) of the network apparatus (200), the unavailability period parameter to the UE in the wireless network (1000).

According to an embodiment of the disclosure, a network apparatus (200) for coordinating an unavailability period parameter of a User Equipment (UE) (100) in a wireless network (1000) may be provided, and the network apparatus (200) may comprise:

a memory (230);

a processor (210);

an AMF controller (240) communicatively coupled to the memory (230) and the processor (210); and

a UE unavailability controller (250), communicatively coupled to the AMF controller (240), configured to receive the unavailability period parameter from the UE (100) using an AMF (200c) of a network apparatus (200), to execute at least one event at the UE (100);

determine, using the AMF (200c) of the network apparatus (200), whether the UE (100) is allowed to become unavailable and to execute the at least one event is accepted; and

send one of an unavailability period parameter accept indication in response to determining that the UE (100) is allowed to become unavailable, perform the NAS procedure to execute the at least one event is accepted by the AMF (200c) or an unavailability period parameter reject indication in response to determining that the UE (100) is not allowed to become unavailable and to execute the at least one event is not accepted by the AMF (200c).

According to an embodiment of the disclosure, the UE unavailability controller (250) may be configured to:

send an event notification report comprising the received unavailability period parameter to one of a PCF (200f), a UDM, and a Network Exposure Function (NEF) (200g) of the network apparatus (200); and

send the event notification report an AF (200a) of the network apparatus (200) using one of the PCF (200f), the UDM or the NEF (200g) of the network apparatus (200).

According to an embodiment of the disclosure, the at least one event may be at least one of a silent reset at a modem of the UE (100), a security patch update at the UE (100), an Operating System (OS) upgrade at the UE (100), a modem software update at the UE (100), a UE reboot upon modem setting changes via Open Mobile Alliance (OMA) Device Management (DM), the network apparatus initiated Detach Request with “Re-Attach Required” and discontinuous coverage of the UEs.

According to an embodiment of the disclosure, the UE unavailability controller (250) may be configured to:

store the received unavailability period parameter using the AMF (200c) of the network apparatus; and

configure the unavailability period parameter to the UE in the wireless network (1000) using the AMF (200c) of the network apparatus (200).

According to an embodiment of the disclosure, a User Equipment (UE) (100) for coordinating an unavailability period parameter of a User Equipment (UE) (100) in a wireless network (1000) may be provided, and the UE (100) may comprise:

a memory (130);

a processor (110); and

a UE unavailability controller (140), communicatively coupled to the memory (130) and the processor (140), configured to:

detect at least one event to be performed at the UE (100);

determine the unavailability period parameter based on the at least one event to be performed at the UE (100);

send the unavailability period parameter to an AMF (200c) of the network apparatus (200);

receive one of an unavailability period parameter accept indication in the NAS message or an unavailability period parameter reject indication in the NAS message from the AMF (200c) of the network apparatus (200); and

perform the NAS procedure to execute the at least one event at the UE (100) based on the unavailability period parameter.

According to an embodiment of the disclosure, the at least one event may be at least one of a silent reset at a modem of the UE (100), a security patch update at the UE (100), an Operating System (OS) upgrade at the UE (100), a modem software update at the UE (100), a UE reboot upon modem setting changes via Open Mobile Alliance (OMA) Device Management (DM), the network apparatus initiated Detach Request with “Re-Attach Required” and Discontinuous coverage of the UEs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an application function (AF) device in a wireless network, the method comprising:
determining a unavailability period parameter for a user equipment (UE) based on at least one event to be performed at the UE; and
sending the unavailability period parameter for the UE to an access and mobility management function (AMF) device,
wherein the unavailability period parameter for the UE is configured by the AMF device.

2. The method of claim 1, wherein the unavailability period parameter for the UE is configured by the AMF device based on at least one operator policy.

3. The method of claim 1, wherein sending, the unavailability period parameter for the UE to the AMF device comprises:
sending the unavailability period parameter for the UE to a policy control function (PCF) device through a network exposure function (NEF) device,
wherein the unavailability period parameter is transmitted by the PCF device during an access and mobility (AM) policy association to the AMF device.

4. The method of claim 1, wherein sending the unavailability period parameter for the UE to the AMF comprises:
sending the unavailability period parameter for the UE to a unified data management (UDM) device,
wherein the unavailability period parameter in a Nudm_subscription data management (SDM)_Get response is transmitted by the UDM device to the AMF device, and
wherein the UDM device uses a UE parameters update through a UDM control plane procedure to configure the unavailability period parameter into the UE.

5. The method of claim 1, wherein the at least one event is at least one of a silent reset at a modem of the UE, a security patch update at the UE, an operating system (OS) upgrade at the UE, a modem software update at the UE, and a UE reboot upon modem setting changes via open mobile alliance (OMA) device management (DM) device.

6. The method of claim 1, further comprising:
storing the received unavailability period parameter; and
configuring the unavailability period parameter for the UE in the wireless network.

7. A method performed by a user equipment (UE) in a wireless network, the method comprising:
identifying at least one event to be performed at the UE;
receiving a unavailability period parameter for the UE from an access and mobility management function (AMF) device in the wireless network to execute the at least one event at the UE;
configuring the unavailability period parameter received from the AMF device; and
performing, a non-access stratum (NAS) procedure to execute the at least one event at the UE based on the configured unavailability period parameter.

8. The method of claim 7, wherein the at least one event is at least one of a silent reset at a modem of the UE, a security patch update at the UE, an operating system (OS) upgrade at the UE, a modem software update at the UE, and a UE reboot upon modem setting changes via open mobile alliance (OMA) device management (DM) device.

9. The method of claim 7, further comprising:
storing the received unavailability period parameter.

10. A method performed by a user equipment (UE) in a wireless network, the method comprising:
identifying at least one event to be performed at the UE;
identifying a unavailability period parameter based on the at least one event to be performed at the UE to execute the at least one event at the UE;
sending the unavailability period parameter to an access and mobility management function (AMF) device;
receiving one of an unavailability period parameter accept indication or an unavailability period parameter reject indication from the AMF device; and
performing a non-access stratum (NAS) procedure to execute the at least one event at the UE upon receiving the unavailability period parameter accept indication from the AMF device.

11. The method of claim 10, wherein the at least one event is at least one of a silent reset at a modem of the UE, a security patch update at the UE, an operating system (OS) upgrade at the UE, a modem software update at the UE, and a UE reboot upon modem setting changes via open mobile alliance (OMA) device management (DM) device.

12. A method performed by an access and mobility management function (AMF) device in a wireless network, the method comprising:
receiving, a unavailability period parameter from a user equipment (UE), to execute at least one event at the UE;
identifying whether UE is allowed to become unavailable, perform a non-access stratum (NAS) procedure to execute the at least one event is accepted; and
sending one of “an unavailability period parameter accept indication in response to determining that the UE is allowed become unavailable, to perform a deregistration procedure and to execute the at least one event is accepted by the AMF device” or “an unavailability period parameter reject indication in response to determining that the UE is not allowed to become unavailable and to execute the at least one event.

13. The method of claim 12, further comprising:
sending an event notification report comprising the received unavailability period parameter from the UE to one of a policy control function (PCF) device, a unified data management (UDM) device, and a network exposure function (NEF) device,
wherein the event notification report is sent by one of the PCF device, the UDM device, or the NEF device to an application function (AF) device.

14. The method of claim 12, wherein the at least one event is at least one of a silent reset at a modem of the UE, a security patch updates at the UE, an operating system (OS) upgrade at the UE, a modem software update at the UE, and a UE reboot upon modem setting changes via open mobile alliance (OMA) device management (DM) device.

15. The method of claim 12, further comprising:
storing the received unavailability period parameter; and
configuring the unavailability period parameter to the UE in the wireless network.

16. A network apparatus for coordinating an unavailability period parameter of a user equipment (UE) in a wireless network, the network apparatus comprises:
a memory;
at least one processor;
an access and mobility management function (AMF) controller communicatively coupled to the memory and the at least one processor; and
a UE unavailability controller, communicatively coupled to the AMF controller, configured to:
receive the unavailability period parameter from the UE using an AMF of a network apparatus, to execute at least one event at the UE,
determine, using the AMF of the network apparatus, whether the UE is allowed to become unavailable and to execute the at least one event is accepted, and
send one of an unavailability period parameter accept indication in response to determining that the UE is allowed to become unavailable, perform the non-access stratum (NAS) procedure to execute the at least one event is accepted by the AMF or an unavailability period parameter reject indication in response to determining that the UE is not allowed to become unavailable and to execute the at least one event is not accepted by the AMF.

17. The network apparatus of claim 16, wherein the UE unavailability controller is further configured to:
send an event notification report comprising the received unavailability period parameter to one of a policy control function (PCF) device, a unified data management (UDM) device, and a network exposure function (NEF) device of the network apparatus, and
send the event notification report an application function (AF) device using one of the PCF device, the UDM device or the NEF device of the network apparatus.

18. The network apparatus of claim 16, wherein the at least one event is at least one of a silent reset at a modem of the UE, a security patch update at the UE, an operating system (OS) upgrade at the UE, a modem software update at the UE, and a UE reboot upon modem setting changes via open mobile alliance (OMA) device management (DM) device.

19. The network apparatus of claim 16, wherein the UE unavailability controller is further configured to:
store the received unavailability period parameter using the AMF device of the network apparatus, and
configure the unavailability period parameter to the UE in the wireless network using the AMF of the network apparatus.

20. A user equipment (UE) for coordinating an unavailability period parameter of the UE in a wireless network, the UE comprises:
a memory;
at least one processor; and
a UE unavailability controller, communicatively coupled to the memory and the at least one processor, configured to:
detect at least one event to be performed at the UE,
determine the unavailability period parameter based on the at least one event to be performed at the UE,
send the unavailability period parameter to an access and mobility management function (AMF) device of a network apparatus,
receive one of an unavailability period parameter accept indication in a non-access stratum (NAS) message or an unavailability period parameter reject indication in the NAS message from the AMF device of the network apparatus, and
perform the NAS procedure to execute the at least one event at the UE based on the unavailability period parameter.
